(19) United States
(12) Patent Application Publication
(10) Pub. No.: US 2006/0190369 A1
(43) Pub. Date: Aug. 24, 2006

(54) Predicting risk and return for a portfolio of entertainment projects

(76) Inventors: Scott Ryles, Atherton, CA (US); William E. Balson, Los Altos Hills, CA (US); Gordon Rausser, Berkeley, CA (US); Mouli Cohen, Belvedere, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/063,376

(22) Filed: Feb. 22, 2005

(51) Int. Cl. G06Q 40/00

(52) U.S. Cl. 705/35

(57) ABSTRACT

A portfolio of entertainment projects is selected such that the risk and return available to investors is attractive compared to other investments. Risk and return for a portfolio of entertainment projects is predicted based on the historical performance of past “similar” projects. In one implementation, characteristics that are predictive of a project's revenue are determined by performing a cluster analysis of historical revenues from past projects. Projects in the portfolio are classified into various segments based on these predictive characteristics. Projects are selected to contruct a portfolio. The risk and return for the portfolio is calculated according to a risk-return model that is based on historical risk and revenue for past projects in the same segment and further based on historical covariance of revenue for past projects in different segments.

### BACKGROUND OF THE INVENTION

1. Field of the Invention

This invention relates generally to predicting the risk and return of a portfolio of entertainment projects, such as in the fields of film, TV broadcast, music and sports.

2. Description of the Related Art

The financing of entertainment projects has historically faced challenges, in part due to the inability to reliably predict the risk and return represented by a specific project or by a portfolio of projects. For example, in the film industry, significant capital is required up front in order to produce and distribute a film. However, financing the production and distribution of films is viewed as a financially risky undertaking. In Entertainment Industry Economics (Cambridge University Press, New York, N.Y., 2001), Vogel summarizes the likelihood of success for individual films by stating “most major-distributed films do no better than to financially break even” (p. 97). He further observes that “[t]en percent of films generate 50 percent of the box office” (p. 126). In Hollywood Economics (Routledge Taylor, & Francis, New York, N.Y., 2004), De Vany states that “[m]ost movies are unprofitable. Large budgets and movie stars do not guarantee success. Even a sequel to a successful movie may be a flop” (p. 82). In our own analysis, a sample of 1,500 films produced over the past ten years reveals that over half lost money but 10% exceeded production and distribution costs by a factor of two or more.

Furthermore, borrowing against a film project is also a risky proposition for many investors since the return from a film project cannot be reliably predicted. It is common wisdom among movie industry experts that film prospects are unpredictable. In Adventures in the Screen Trade (Warner Books, New York, N.Y., 1983), Goldman wrote “Nobody knows anything” (p. 91). DeVany made this conclusion more precise in reporting his extensive regression analysis of a historical dataset of 2015 films (p. 91 of Hollywood Economics), concluding that “[t]he equation is a very poor fit, with an R-squared of just 0.118” (p. 94). He further concluded that “forecasting revenue is futile because the magnitude of the forecast variance completely overwhelms the value of the forecast” (p. 90). Vogel concludes “[t]he financial performance of a movie is unpredictable because each one is unique and enters the competition for audiences in a constantly shifting marketing environment” (p. 97). In “Information, Blockbusters and Stars: A Study of the Film Industry” (Journal of Business, 1999, Vol. 72, No. 4), Ravid presents similar results.

In an attempt to reliably predict revenue, many factors thought to affect movie financial performance have been analyzed extensively. In “21 Fundamental Aspects of U.S. Theatrical Film Biz” (Daily Variety, Oct. 26, 1982), Murphy observed that films “cannot be test marketed in the usual sense.” DeVany's analysis made that more precise by analyzing a host of factors such as budget, stars, sequels, genre, rating, screens, box office life, and year of release. He concluded “There are no formulas for success in Hollywood” (p. 98). In “The Golden Formula for Hollywood Success” (New York Times, Mar. 23, 2000), Postrel concluded his analysis with the observation that “Most stars do not really make a difference.” Ravid also summarizes various studies on the influence of individual factors on movie financial performance.

In addition to the unpredictability of film revenue, outside financial investors typically also do not have access to high quality data or models on which to base predictions of film revenues. Another impediment to film financing is that outside investors often cannot understand or exploit the challenging legal and accounting issues that define how much each party involved in financing a film's production and distribution receives out of the total revenues a film achieves (often referred to as the “ultimate revenue”, which includes box-office receipts, foreign distribution, cable TV and VHS/DVDs).

As a result of these risks and unpredictability, it is generally difficult to predict the risk and return of film projects. Consequently, outside investors historically have been reluctant to finance film projects. This, in turn, has forced the film industry to rely on financing from production companies or financing techniques that reduce the risk inherent in film investing through tax advantages. Still, other funds are raised from individuals who either seek non-economic returns or think they can select the better projects more accurately than others.

Much financing for film production (estimated at about $6 billion annually) comes from internally generated funds and co-production deals. Studios are able to manage the financial risks in part by shifting financial risk to outside investors. One mechanism for shifting risk is the so-called negative pick-up deal in which a studio will pay for the film negative after its completion, after many of the production risks are resolved. Another mechanism for shifting risk is the so-called gap insurance policies, which offer default protection for loans to producers. Coproduction deals, in which several studios share production costs and divide distribution rights, can be used to share risk among studios, particularly for large budget films.

Commercial banks and other credit facilitators such as insurance companies make up the bulk of the remaining sources of film financing. Loans made to studios and producers are generally collateralized with both revenues from the defined films and from balance sheet guarantees provided by the parent corporation. Banks are generally averse to making non-recourse loans against individual films due the high risk of a flop, and tend to prefer loans against an entire annual slate of studio films to avoid adverse selection. Banks also tend to prefer to make loans at or after release of a film when future revenues are more predictable, compared to earlier in the production cycle. Loans can also be arranged when all or portions of the distribution rights have been pre-sold to a major studio in a manner allowing the distribution agreement to be used as collateral against the loan. In these cases, lenders typically finance only a portion of the total cost of production and promotion.

Film studios have attempted to use a slate of film projects as collateral against bank borrowing or other types of financing. For example, in 2002, Dreamworks developed a financing securitization scheme in which $1 billion was advanced by institutional investors against collateral in 36 films and additional cash advances were made after release of new films. In 2003, CIBC World Markets restructured Village Roadshow's co-financing arrangement with a fund comprised of $900 million in borrowings and $100 million in equity. Paramount recently announced in October 2004 an equity investment fund arranged by Merrill Lynch in which up to $300 million will be invested in more than 20 movies and receive a portion of the worldwide profits in return. Furthermore, a slate, by definition, is typically defined as all of the film projects undertaken by a studio during a certain time period. As such, the film projects in the slate have not been selected to diversify risk or to enhance the overall risk/return of the slate.

Other film investment alternatives that have been offered to the public include common stock and limited partnerships for film projects. These have historically represented a small portion of overall production financing due to the difficulties of structuring and marketing these investments. A common stock offering for a film project suffers from the high risk and the long-time (generally 2-5 years) before the film project generates cash flows for the investors. As a result, the required annual investment returns required to compensate investors at a level commensurate with the financial risks exceed the average returns for a typical film. Examples of attempts to introduce common stock offerings for films include Kings Road Productions and Civilian Capital. Limited partnerships have typically been used to capture tax benefits, however, most of the tax benefits once available have been severely curtailed. Examples of such limited partnerships include Silver Screen Partners and SLM Entertainment Ltd. High management fees combined with high risk typically limits the returns to less than investors could have achieved by simply investing in production and/or distribution companies.

One significant drawback to most, if not all, of these financing approaches is an inability to establish a risk-adjusted value for each project and a comparable value for a portfolio of projects based upon the individual characteristics of each project and a desired risk-return profile of the entire portfolio. Lenders use portfolios of a slate of movies made by a single studio as collateral, but tend to not take risk based upon each title. Studios and production companies commit capital to individual films based upon their estimate of the likelihood the public will pay more than the cost of making the film. Media and entertainment companies invest in films as part of a larger enterprise in multiple media distribution channels, production assets and marketing capabilities. Thus, there is a need for approaches that more reliably predict the risk and return of portfolios of entertainment projects, enabling these entertainment projects to access the capital offered by the developing securities markets.

### SUMMARY OF THE INVENTION

The present invention overcomes the limitations of the prior art by predicting risk and/or return for a portfolio of entertainment projects based on the historical performance of past projects and by enabling construction of portfolios of projects that overcome the financial risk limitations of current methods. In one implementation, attributes that are predictive of a project's revenue and revenue risk are determined, at least in part, by performing a cluster and/or regression analysis of historical revenues from past projects. These attributes are referred to as predictive characteristics. They preferably are both predictive of revenue and not strongly correlated with each other. These predictive characteristics are then used to predict the risk and/or return of the portfolio of projects.

In one approach, projects are classified into segments based, either solely or in part, on their predictive characteristics. A risk-return model is built based on historical risk and revenue for past projects in the same (or similar) segments and further based on historical covariance of revenue for past projects in different segments. In two extended approaches, a composite combination function or a Bayesian model can be used to combine expert judgment with the historical data. Projects in the portfolio are classified into segments based on their predictive characteristics. The risk and return for the portfolio is calculated according to the risk-return model.

In one example, a clustering and regression of past film projects identified production budget, star power, director power, genre rank, rating rank and release date as good predictive characteristics. Production budget measures the amount budgeted (or actually used) for production of a film project. Star power and director power are measures of the importance or value of the actors/actresses and director, respectively. In one approach, these quantities are based on the revenue performance of past film projects for the actors/actresses and/or director. Genre rank takes into account the genre of the film project (e.g., science fiction, thriller, animation, etc.). Rating rank is based on the film's rating (e.g., G, PG, R, etc.). Release date is based on the release date of the film.

Cluster and/or regression analysis of past film projects is used to group these predictive characteristics into a few clusters (typically two or three). The covariance between different predictive characteristics is calculated based on past film projects. In order to predict the risk and return for a portfolio of new film projects, each film project is classified into a segment based on the predictive characteristics for that film project. The film project is assumed to follow the statistical financial model for that segment, which is calculated based on past film projects in the same (or similar) segments. The predicted performance of the portfolio can be calculated by combining the statistical models for each of the individual film projects in the portfolio, taking into account covariance of the different quantities. In a well constructed portfolio, the covariance will reduce the risk of the overall portfolio.

Other techniques can be used in addition to cluster analysis to improve the risk-return model. For example, regression analysis can be performed to develop predictive characteristics that are less correlated and/or to reduce the total number of predictive characteristics. In one model, star power and director power are combined using regression analysis to develop a single predictive characteristic—cast power—that accounts for the importance or value of actors, actresses and directors. As another example, once the predictive characteristics are identified, either cluster or non-cluster-based techniques can be used to predict the risk and return of a portfolio as a function of the predictive characteristics.

In another aspect of the invention, a portfolio of entertainment projects is assembled as follows. A target return is defined. The goal is to assemble a portfolio of entertainment projects with an expected return consistent with the target return, but with reduced risk (e.g., due to diversification and careful selection of the projects and project segments in the portfolio). Candidate projects are either included in the portfolio or not based on the extent that the candidate project “contributes” to reaching the overall goal. For example, candidate projects may contribute by adding to the return of the portfolio, diversifying the risk or the portfolio, or in other ways. The contribution of each candidate project can be determined, for example, by using the risk-return model described above. Note that the contribution of each project will depend, in part, on which other projects are in the portfolio due to their covariance relationship.

Another aspect of the invention provides for financianing a portfolio of film projects. Here, a target portfolio of film projects is defined. The target film projects are descriptions of film projects (e.g., projects that fall in segment A, that have a specific release date, etc.) and they are selected based on a predicted risk and predicted revenue for the target portfolio, for example using the risk-return model described above. Capital commitments from various entities (e.g., individuals, banks, insurance companies) are raised based on the predicted performance of the target portfolio. A portfolio of actual film projects is constructed to match the description of the target portfolio. Rights to revenues from the actual film projects are acquired (or granted) in return for capital from the capital providing entities. The actual film projects meet the descriptions set for the target portfolio. The predicted risk and predicted revenue of the portfolio of actual film projects should be similar to that of the target portfolio, as calculated according to the risk-return model.

In yet another approach for assembling a portfolio, the predictive characteristics are used to determine which film projects and/or segments are categorically “undesirable” due to their adverse contribution to expected return or risk. For example, the risk-return model may predict that the standard deviation of revenue is significantly greater than the expected revenue for certain segments. This information may be used to set a criteria to reject film projects. For example, all film projects classified in the undesirable segments may be automatically rejected for inclusion in the portfolio. The remaining film projects may be further analyzed for possible inclusion in the portfolio. In many cases, it is more important to intelligently reject bad film projects than to intelligently select good film projects.

In yet another aspect of the invention, the portfolio is securitized. In one approach, the portfolio is securitized by two or more securities representing different risk-return characteristics. The securities provide various types of rights to proceeds from the films in the portfolio. The securities are then offered through to various investors to raise capital to finance the production of the films in the portfolio. The securities are preferably grouped into various tranches, each tranche having defined risk/return characterstics and rights to selected portions of the proceeds. Proceeds from the distribution of the films are then distributed to the securities holders.

Other aspects of the invention include methods, devices and systems corresponding to inventive aspects described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a flow diagram of one method for predicting the financial performance of a portfolio of film projects, according to the present invention.

FIGS. 2-5 are cluster diagrams showing clustering of film projects by production budget, star power, genre and release date, respectively.

FIG. 6 is a table illustrating one approach to selecting predictive characteristics.

FIG. 7 is an example of covariance and correlation matrices for the selected predictive characteristics.

FIG. 8 is a table illustrating classification of a film project into a segment.

FIGS. 9A-9C are flow diagrams of different methods for assembling a portfolio of film projects, according to the present invention.

FIG. 10 is a flow diagram of one method for securitizing a portfolio of film projects.

FIG. 11A is a cumulative distribution function for gross box office receipts from a portfolio of film projects.

FIG. 11B is a table showing different tranches for the distribution function of FIG. 11A.

### DETAILED DESCRIPTION OF THE PREFERRED EMBODIMENTS

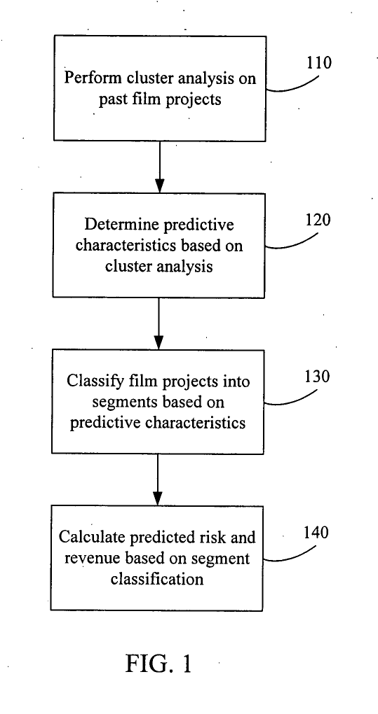

FIG. 1 is a flow diagram of one method for predicting the financial performance of a portfolio of film projects, according to the present invention. The method is based in part on the historical performance of past film projects and in part on portfolio theory. In steps 110 and 120, historical data is analyzed to determine a set of film characteristics that are predictive of revenue. These characteristics are referred to as predictive characteristics. In this example, a cluster analysis 110 of revenue as a function of various film attributes is performed for past film projects. Based on this cluster analysis, certain attributes are selected 120 as the predictive characteristics. Alternatively, the cluster analysis can be used to determine 120 the predictive characteristics even though the original attributes themselves are not the predictive characteristics. For example, the predictive characteristics may be defined as combinations of various attributes.

Furthermore, non-cluster-based techniques can be used in addition to cluster analysis to further improve the predictive characteristics. For example, if cluster analysis suggests that certain attributes or combinations of attributes are good candidates for predictive characteristics, regression analysis can be performed to further refine the definition of the predictive characteristics. As a specific example, if a predictive characteristic is defined as a weight sum of certain attributes, regression analysis may be used to determine the “optimal” values of the weights. Regression analysis can also be used to reduce the correlation between different predictive characteristics and/or to reduce the total number of predictive characteristics (e.g., by combining predictive characteristics that are more strongly correlated).

In addition, although FIG. 1 may suggest that steps 110 and 120 are performed only one time in the order shown, this is not necessarily the case. The cluster analysis, selection and definition of predictive characteristics and building of a risk-return model typically is performed iteratively. Which past film projects are included in the cluster analysis, the type or granularity of the cluster analysis, the cluster boundaries, the definitions of the predictive characteristics, and the statistical models underlying the risk-return model are all quantities which may be iterated.

Referring again to FIG. 1, in steps 130 and 140, the set of predictive characteristics is used to predict the financial performance of the portfolio of film projects. In this particular implementation, the predictive characteristics are used to define different film classes or “segments” and the film projects in the portfolio are classified 130 into these segments according to their predictive characteristics. A risk-return model is created based on the historical risk and revenue for past film projects in the same segment and also based on the historical covariance of revenue for past film projects in different segments. This risk-return model is used to calculate 140 the predicted risk and revenue of the portfolio of film projects, based on the segment classification of the film projects. Accounting for the covariance between film projects in different segments produces a more accurate prediction. In addition, the covariance can reduce the overall risk of the portfolio as a whole compared to the cumulative risk of the individual film projects in the portfolio, in accordance with modern portfolio theory.

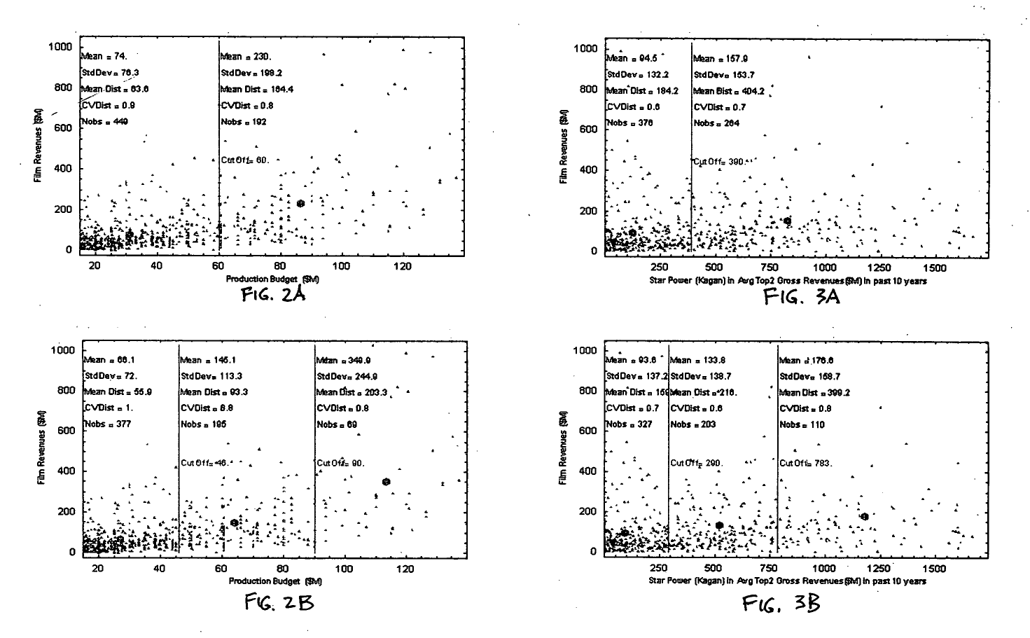

FIGS. 2-7 show an example in more detail. Historical data about the past performance of film projects and different attributes of film projects can be obtained from a large number of sources. Examples include Adams Media Research, FilmFinders Film Data Service, Hollywood Stock Exchange, Internet Movie Database, Kagan World Media/The Kagan Group, Nielsen EDI and Rentrak. Additional examples of free sources include Alexander & Associates, Amelie Movie Guide (including CinemaScore), BigScreenBiz, Box Office Guru, Box Office Mojo, FilmStew, Foster Business Library, Indiewire, Matrixx Films Entertainment, MetaCritic, Motion Picture Association of America, The Movie Times, MovieWeb, National Association of Theater Owners Online, National Cinema Network, The Numbers, Rasp New Movie Database, Rotten Tomatoes, ShowBizData and TeacherOz.com. Further examples of fee-based sources include Exhibitor Relations Co., Hollywood Reporter, MovieLine Intl., Production Weekly and Wilkofsky Gruen Associates.

These sources contain large amounts of information about past film projects. This information can be financial (e.g., film budget, box office revenue, DVD revenue, etc.) as well as non-financial (e.g., cast, director, MPAA rating, etc.). Some examples of film attributes include Production Budget, Print & Advertising Budget, Cost/Expense, Language (w/ and w/o subtitles), Sequel/Prequel, Effects (special/technical), Forecast/Projection (revenue, etc.), Format (Color, B & W, Colorized, Silent vs. Talking), Genre/Plot, Location (film setting), Studio (major vs. indie), Distributor/tion, Rating (MPAA/CARA), Release (date, schedule, season, timing, holiday—age specific and seasonal), Run Time (minutes), Soundtrack/Composer, Title (new release, post-theatrical release such as to home DVD/video), Awards (Audience, People's Choice, Oscar, Golden Globe, Festival, etc.), Intensity of Competition, Domestic Box Office Earnings (early/first wk. %—“legs”, daily, weekend, weekly, monthly, annual, all-time, holiday, gross, net, adjusted), Geography (distribution of theater release locales), Number of Prints, Reviews (Critical, Public/Audience), Screen/Theater Count (open, close, apex/widest number), Test-Screening/Sneak Preview, Ticket (prices), Weeks Run/Rank, and Target Market (Demographics, Geographic, Media, Ancillary).

In addition to the attributes provided by various sources, secondary attributes can also be constructed by combining various pieces of information. For example, all revenue numbers may be combined to form a secondary attribute of total revenue (if that attribute is not available from a source). As another example, “Power Ratings” can be calculated for the cast, crew, director, studio, etc. The Power Rating for an actor may be defined as the total revenue generated by his/her last five film projects, for example. Other definitions can also be used.

The following example is based on a historical database of approximately 600 film projects with approximately 50 attributes compiled from a large number of different sources. These film projects were released between 1998 and 2002 and had production budgets of $15 million or greater. In this example, a cluster analysis is performed for each of the attributes. FIGS. 2-5 are cluster diagrams showing clustering of film projects by production budget, star power, genre and release date, respectively.

FIGS. 2A-2B show two example clusterings. In these examples, film revenue is clustered as a function of Production Budget. Net revenue available to a major studio is used as the measure of revenue, although other measures could also be used. Film net cash flow, domestic box office, international box office, DVD sales, and cable/TV sales are some examples. In FIG. 2A, the past film projects are grouped into two clusters. In FIG. 2B the past projects are grouped into three clusters. The vertical line(s) shows the cluster boundaries, as does the legend “Cutoff=xxx.” The other legends give statistics for each cluster. For example, in FIG. 2A, the cutoff between the low revenue cluster and the high revenue cluster occurs at a Production Budget of $60 million. The low revenue cluster has a mean value (Mean) of $74 million, a standard deviation (StdDev) of $76.3 million, a mean cluster distance (Mean Dist) of 63.6, a variance of cluster distance (CVDist) of 0.9, and the cluster contains a total number of observations (Nobs) of 449.

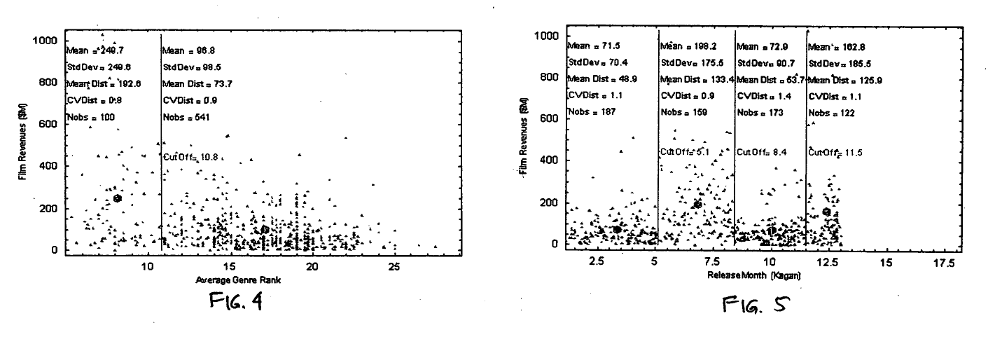

FIGS. 3A-3B also show two example clusterings, but with respect to Star Power rather than Production Budget. Star Power is a measure of the importance or value of various cast members. In this particular example, Star Power is formulated as a weighted average of the prior box office revenues of the top five credit-billed stars. Other formulations can also be used. Including different numbers of stars, time-weighting (e.g., weighting revenues from recent projects more heavily than revenues from distant projects), and consistency of a star's hits are some example variations. The two examples in FIG. 3 are organized the same as in FIG. 2: two clusters vs. three clusters.

FIG. 4 shows an example clustering of film revenue as a function of genre. Different genre could include sci-fi, fantasy, animation, action, comedy, drama, family, horror, romance, romantic comedy, thriller, western, etc. One difference between FIG. 4 and FIGS. 2-3 is that the genre attribute does not have a natural ordering. In order to cluster a set of data points, the points are given (x,y) coordinates (for two-dimensional clustering) and these are then clustered. In FIGS. 2-3, the x coordinate is the Production Budget or the calculated Star Power, respectively, since these are numerical values and therefore have a natural order to them. However, values such as “drama” and “horror” do not have a natural order—does “drama” come before or after “horror”? In this example, the values are ordered according to their revenue. The average revenue for all past film projects in one genre are calculated, the different genre are rank ordered from lowest to highest mean revenue, and each genre is then assigned an x coordinate equal to its ordinal rank. The genre with the lowest mean revenue is assigned an x coordinate of 1, the second lowest is assigned x=2, etc. Other orderings can also be used. For example, each genre can be assigned an x coordinate equal to its actual mean revenue (as opposed to the ordinal rank). For films which fall into multiple genres, the x coordinates are averaged to produce the Average Genre Rank.

FIG. 5 shows an example clustering of film revenue as a function of release date. In this example, the x coordinate is the release date in months (the Release Month). January 1 corresponds to x=1+1/31=1.03, January 31 corresponds to x=1+31/31=2.00, February 1 corresponds to x=2+1/28=2.04, etc. The total range for x is roughly 1 to 13. In this example, the data initially falls into four groupings. However, the first and third groupings are similar, as are the second and fourth groupings. Therefore, these groupings are combined, yielding a total of two distinct clusters for this attribute. The low revenue cluster includes the first and third groupings, and the high revenue cluster includes the second and fourth groupings.

In the above example, the cluster analysis is performed for attributes that are candidates for the set of predictive characteristics. These attributes can include secondary attributes, such as star power, in addition to attributes directly provided in the source data. In this example, due to the sample size, the attributes preferably are grouped into a small number of clusters, typically two or three, as is shown in the examples of FIGS. 2-5. The total number of clusters preferably is not more than four in order to not reduce statistical power due to sample size issues.

Clustering, or other non-parametric approaches, is preferred because the data is highly scattered. Cluster analysis has become a useful tool in modern statistical analyses of problems in which there is a desire to not impose parametric distributional assumptions. A cluster analysis approach attempts to identify groupings or natural clusters within the data. The data are generally composed of a sample of observations of characteristics of the underlying population. In this example, the data are based on past film projects. Conventional clustering algorithms can be used to perform the cluster analysis. Cluster analysis can also be widely used to identify outlier data points in large datasets. In one approach, these outlier points are removed from the data set and the cluster analysis is then iterated.

Most other statistical methods impose parametric assumptions on the structure of the data and prior belief about errors in the data. For example, a step-wise linear regression analysis (often called ordinary least-squares or OLS) would begin by hypothesizing a parametric model, estimating the parameters of that model, and then adding or deleting model parameters to balance the model complexity against the improvement in standard error measures gained by adding parameters. As a result, parametric approaches typically are not as suitable for highly scattered data sets, although they may be used for other purposes or in conjunction with non-parametric approaches (e.g., if the non-parametric analysis suggests an underlying structure).

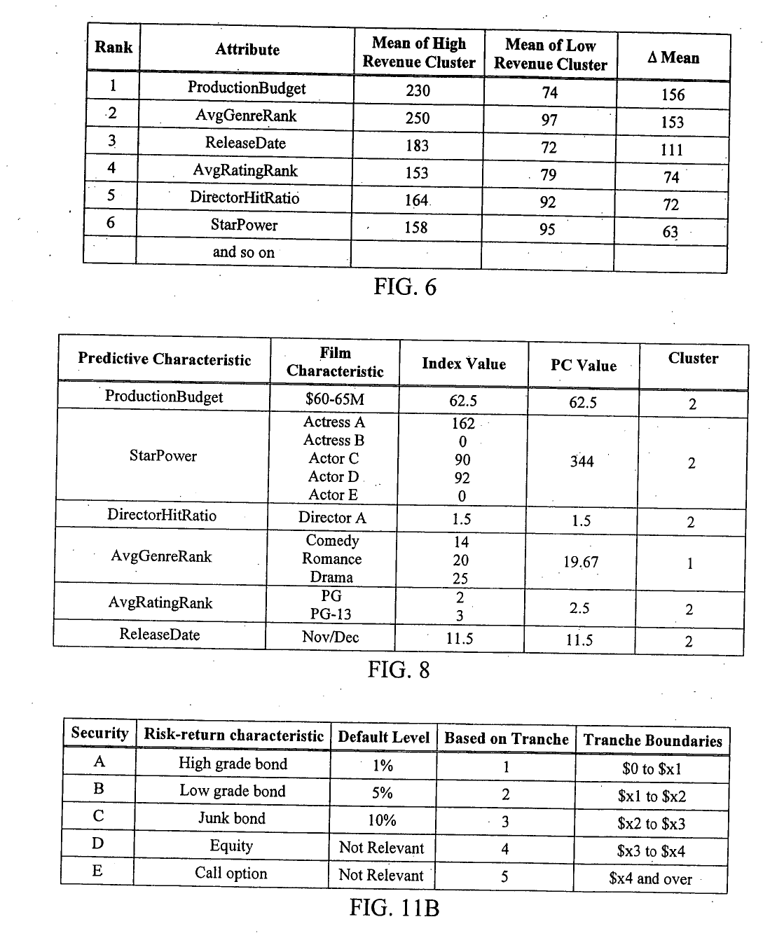

FIG. 6 illustrates one approach to selecting the set of predictive characteristics. For each attribute, the difference between the mean revenue for the highest revenue cluster and the mean revenue for the lowest revenue cluster is calculated (shown as Δ Mean in FIG. 6). The attributes are rank ordered from the largest Δ Mean to the smallest Δ Mean. The attributes with the larger differences are preferred since larger differences suggest that attribute is more predictive of revenue. Other types of sensitivity analysis can also be performed.

In a simple approach, the top-ranking attributes are selected as the set of predictive characteristics. More sophisticated approaches can also be used. For example, if two of the top-ranking attributes are highly correlated (e.g., if a large number of the film projects in the low revenue cluster for one attribute are also in the low revenue cluster for the other attribute, and the same for the high revenue cluster), then one of these attributes may be removed from the set of predictive characteristics since it is redundant. It may be replaced by the next highest-ranking, less correlated attribute. To take this approach one step further, the predictive characteristics may be formed as combinations of the attributes, for example via a principal components analysis. Alternately, regression or other techniques can be used to refine the definitions of the top-ranking attributes to make them less correlated.

In this particular example, a set of six predictive characteristics were selected: ProductionBudget, StarPower, DirectorHitRatio, AvgGenreRank, AvgRatingRank and ReleaseDate. StarPower is calculated as a sum of past revenues for the top five stars, where the revenues are weighted over time. DirectorHitRatio is calculated as the percentage of hits by a director where a hit is defined as a film that exceeds a threshold revenue level. AvgGenreRank and AvgRatingRank are the ordinal rankings of mean revenue for all past film projects in a certain genre or with a certain MPAA rating, as illustrated in the context of FIG. 4 above. In this example, the ratio of the mean revenue for the highest revenue cluster to the mean revenue for the lowest revenue cluster was approximately in the 2:1 to 3:1 range.

Each of these six predictive characteristics was grouped into either two or three clusters. Thus, the space of film projects can be represented by sextuples of the form {a, b, c, d, e, f} where each number a-f represents one of the clusters for one of the six predictive characteristics. The space of film projects can then be divided into segments, where each segment contains one or more of the sextuples. In this particular example, if each sextuple is treated as a different segment, there will be a total of 2*2*2*3*3*3=216 segments.

The number of predictive characteristics, clusters per predictive characteristic, and segments will depend in part on the sample size of past film projects. In this particular example, 5-10 predictive characteristics, 2-3 clusters per predictive characteristic and not more than 300 segments are preferred. In one variant, StarPower and DirectorPower were combined into a single predictive characteristic, and AvgGenreRank and AvgRatingRank were also combined into a single predictive characteristic. This reduces the number of predictive characteristic to four, allowing for a larger number of samples in each segment.

In the example given above, the predictive characteristics were selected based on initial clusterings. In alternate embodiments, an iterative approach can also be used. For example, if the revenue model is being developed in order to assemble a portfolio of film projects, certain film projects may not be good candidates for the portfolio. It may be desirable to exclude segments in which film projects have a high probability that they will not recover their initial costs. For example, if the standard deviation for a segment is significantly greater than the mean revenue for the segment, that segment runs a significant risk of being financially unsuccessful. At the opposite end of the spectrum, franchise films and megahits (e.g., films with large production budgets, megastars and/or directors and high profile release dates) may also be unlikely candidates since studios may refuse to bundle these projects with others as part of a portfolio or the magnitude of the project may overwhelm the other projects in the portfolio, thus diluting any diversification effects. In one approach, these films/segments are identified based on their sextuples and then excluded from the pool of past film projects. The clustering analysis is then performed again based on the pool without the excluded film projects (i.e., considering only segments relevant to the final application).

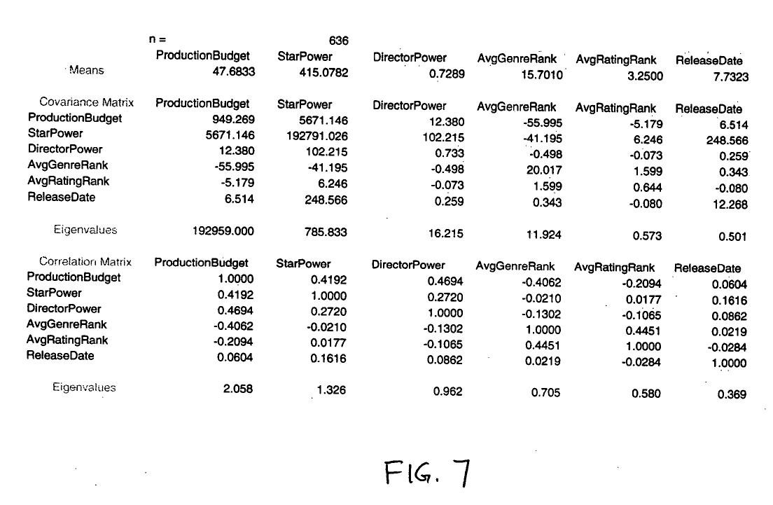

Once the steps in FIGS. 2-6 are completed, a set of predictive characteristics has been determined and segments have been defined based on the predictive characteristics. Furthermore, there is historical data underlying these choices. A risk-return model can be built based upon the segments and the underlying past film projects. For example, all of the film projects that fall within one segment can be analyzed for risk and/or return (e.g., by calculating the mean revenue and standard deviation for past film projects within the segment). Furthermore, the covariance of revenue can also be calculated. For example, the covariance between the different predictive characteristics can be expressed as a covariance matrix, an example of which is shown in FIG. 7. FIG. 7 also shows the cross-correlation matrix between the six predictive characteristics. The predicted risk and revenue (e.g., profitability) for a portfolio of film projects can then be calculated based on these quantities.

In one approach, each of the film projects in the portfolio is classified into a segment based on the predictive characteristics for that film project. FIG. 8 shows an example. This particular film project has a ProductionBudget of $60-65 million. This range is averaged to arrive at a single value of $62.5 million, which places the film project in cluster 2 for the predictive characteristic ProductionBudget. StarPower is based on the top five cast members, which have individual StarPowers as shown. Note that two of the cast members have StarPowers of 0. The StarPower for the film project is the sum of these individual StarPowers: 345. This falls in cluster 2 for StarPower. The DirectorHitRatio is 1.5, which falls in cluster 2. This film project falls into three genres: comedy, romance and drama. The average ordinal ranking of 19.67 places this film project in cluster 1 for AvgGenreRank. Similarly, the PG or PG-13 MPAA rating places this film project in cluster 2 for AvgRatingRank. Finally, the holiday season release date places this film project in cluster 2 (i.e., the cluster that contains the first and third groupings in FIG. 5). The sextuple for this film project is {2, 2, 2, 1, 2, 2}.

Once classified into a segment, the film project is assumed to have the same characteristics as the statistical quantities for that segment, as calculated based on past film projects in the same segment. In this example, assuming that the segment is defined by the sextuple {2, 2, 2, 1, 2, 2}, the mean revenue and standard deviation for past film projects in this sextuple are assumed to statistically describe this film project. In an alternative approach, statistical quantities may be calculated based also on past film projects in other similar segments. For example, if there are too few past film projects in a particular segment, film projects from neighboring segments may also be used.

The predicted performance of the portfolio can be calculated by combining the statistical models for each of the individual film projects in the portfolio, taking into account covariance of the different quantities. The statistical mathematics of computing portfolio properties from the properties of the underlying assets is well known and described in numerous textbooks. Note that covariance can be used to reduce the overall risk of the portfolio. A qualitative guideline for constructing efficient portfolios is to combine weakly or negatively correlated assets. The resulting risk and return of the portfolio can be superior to that of the individual film projects, and a portfolio constructed in this manner is typically superior to one constructed by selecting film projects on an individual basis without regard to their covariance.

For efficiently constructed portfolios, there is an opportunity to buy revenue streams from individual film projects at a relatively lower price (because of the higher volatility associated with an individual film project) and then sell revenue streams from the portfolio at a relatively higher price (because of the lower overall volatility associated with the portfolio). Portfolios preferably contain approximately 20 film projects, with no significant outliers, in order to achieve this diversification effect. One advantage of the current approach is that a portfolio can include film projects from multiple studios, rather than film projects from only a single studio.

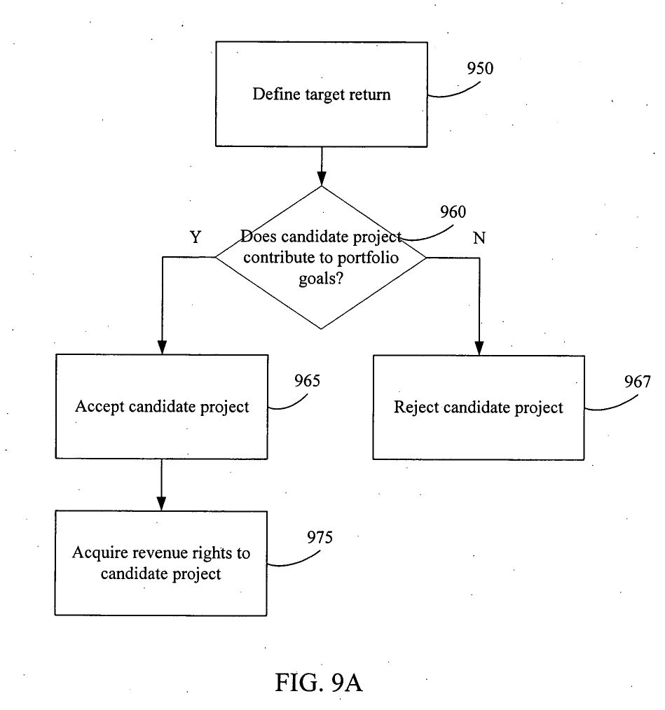

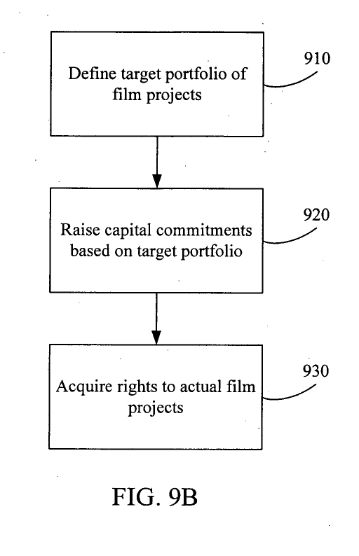

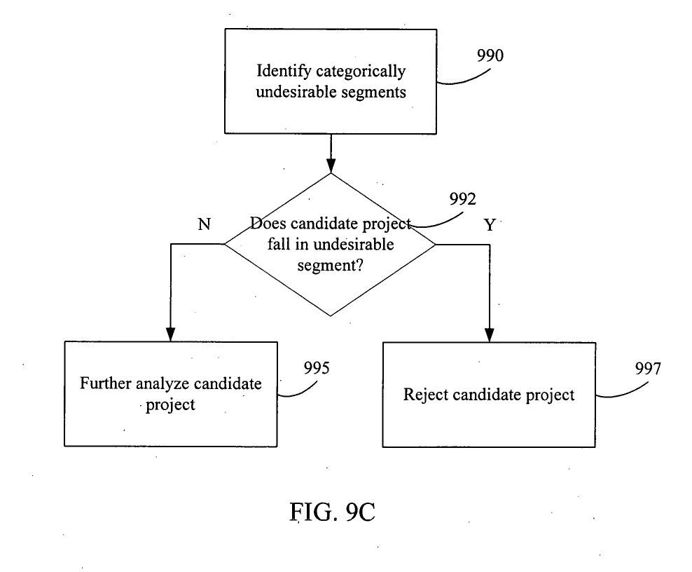

FIG. 9A is a flow diagram of one method for assembling a portfolio of film projects, according to the present invention. A target return for the portfolio is defined 950. The goal is to assemble a portfolio of film projects with an expected return consistent with the target return, but with reduced risk (e.g., due to diversification of the projects in the portfolio). Investors are generally concerned with both returns and the risk of loss of their capital. It has become commonplace to rate investments according to both risk and reward. One measure of financial risk is the standard deviation of returns. The ratio of excess returns to the standard deviation of returns is often called the Sharpe ratio. The Sharpe ratio is useful to investors because it indicates the return per unit of risk.

According to portfolio theory, there is an “efficient frontier” of portfolios, which represents the best opportunities for gain with the least risk. Portfolios which lie along the efficient frontier represent the maximum return for a given amount of risk, or the least amount of risk for a given return. These portfolios will dominate portfolios not on the efficient frontier and economically rational investors should select a portfolio that lies on the efficient frontier.

One possible goal, then, is to assemble a portfolio that lies along the efficient frontier for a given return. Furthermore, although any one project in the portfolio may not lie along the efficient frontier, the aggregate effects of all projects in the portfolio may push the overall risk-return characteristic of the portfolio to the efficient frontier. Thus, candidate film projects are either included 965 in the portfolio or not 967, depending 960 on the extent that the candidate project “contributes” to reaching the overall goal (e.g., moves the risk-return characteristic of the portfolio towards the efficient frontier). The contribution of each candidate project can be determined, for example, by using the risk-return model described above. Note that the contribution of each project will depend, in part, on what other projects are in the portfolio.

If a candidate project is selected 965 for inclusion in the portfolio, then rights to revenues from the project are acquired 975. The price paid for these rights can be determined in a number of ways. The capital asset pricing model (CAPM) is one widely applied method of adjusting the prices of securities to reflect the market value of risk. The CAPM model adjusts the prices for the standard deviation of price changes relative to a market portfolio. It thus reflects one risk factor (i.e., the market portfolio) and two moments of the observed frequency distributions on changes in the prices of securities (i.e., the mean and standard deviation). Arbitrage pricing theory (APT) is a method that extends the concept of risk-adjusted pricing to multiple factors, using a linear model to correlate asset price changes to changes in the factors analyzed. Other approaches extend risk-adjusted pricing to additional moments of the price distributions in order to capture risks due to skewness and kurtosis. Principal component analysis (PCA) or analysis of variance (ANOVA) are techniques often used to select the factors included in a multi-factor model of risk-adjusted prices.

FIG. 9B is a flow diagram of another method for assembling a portfolio of film projects, according to the present invention. A target portfolio of target film projects is defined 910. For example, a target portfolio may include 3 projects from segment A, 2 projects with a specific genre and MPAA rating, etc. The target film projects are not actual film projects. Rather, they are descriptions or requirements of film projects (e.g., any film project that would fall into segment A). The target portfolio preferably achieves diversification due to covariance between films projects from different segments.

The predicted risk and return of the target portfolio can be calculated based on the model described above. Capital commitments are raised 920 based on the predicted risk and return. Then, the actual portfolio is constructed by using the capital commitments to acquire 930 rights to actual film projects. The film projects are selected based on the criteria set for the target portfolio. Prices for individual film projects can be calculated in a number of ways, for example by allocating the predicted revenue for the overall portfolio or by using a differential analysis to decompose the value of the overall portfolio on a project-by-project basis.

Preferably, this approach is advantageous to both the movie studio and to the organizer of the portfolio. The movie studio preferably can finance the film project in a manner that is less costly than conventional approaches. The organizer preferably can purchase rights to film projects at prices that allow him to profit by assembling the individual film projects into diversified portfolios.

FIG. 9C is a flow diagram of yet another method for assembling a portfolio of film projects, according to the present invention. As described above, certain film projects or certain segments may be identified 990 apriori as categorically undesirable for inclusion in the portfolio. For example, if the Sharpe ratio for a segment is below a certain threshold, all film projects classified in that segment may be rejected 997. Film projects which are not rejected 995 may be further analyzed for possible inclusion in the portfolio. In many cases, the important decision is not to identify which film projects should be included in the portfolio but to identify which film projects should not be included in the portfolio. The elimination of undesirable film projects may be a significant step in assembling a successful portfolio of film projects.

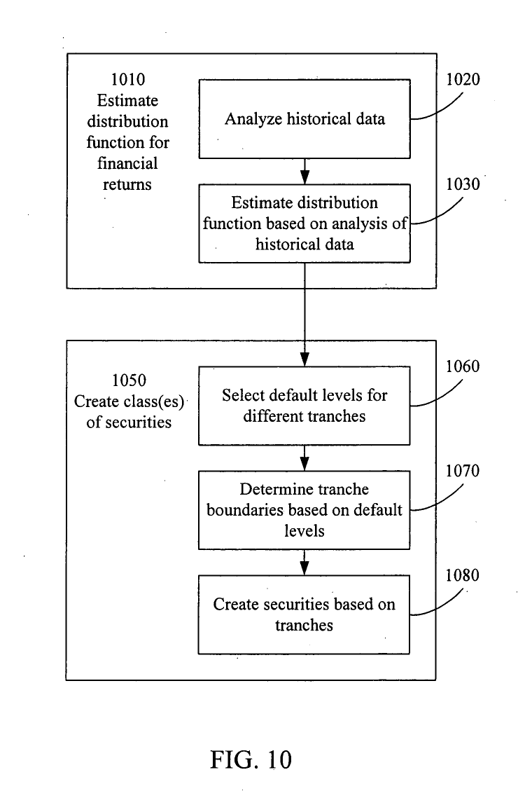

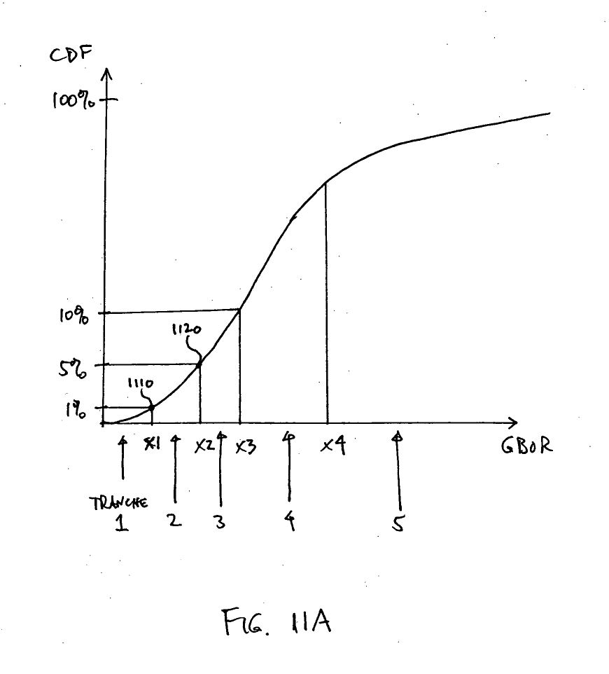

FIGS. 10-11 illustrate one method for securitizing the portfolio of film projects. In one approach, a distribution function for financial returns from the film projects in the portfolio is estimated 1010. One or more classes of securities are then created 1050 based on the distribution function. In cases where there is more than one class of security, the different classes of securities can represent different risk levels for the financial returns from the portfolio. The different risk levels preferably are tailored to match established markets so that the securities can be sold and traded more easily. For example, some classes may be more bond-like in their risk-return characteristic, while other classes may be more equity-like or option-like. Within the bond-like classes, different securities may be similar in risk-return to different grades of bonds: AAA down to junk bond status.

One advantage of offering multiple classes of securities is that different investors may assume different levels of risk and return. Conservative investors can finance the portfolio by buying the less risky bond-like securities. Aggressive investors can satisfy their desire for upside return by buying the option-like securities. Thus, the use of multiple classes of securities preferably will encourage financing from investors that otherwise might shy away from a single class of security. In addition, the overall cost of capital can be reduced since, for example, a lower return can be paid to the conservative investors since they are assuming less risk.

The interior of boxes 1010 and 1050 show example implementations of these two steps. This specific implementation will be discussed in the context of FIGS. 11A-11B, which show a cumulative distribution function for gross box office receipts (GBOR) from a portfolio. Each (x,y) point on the cumulative distribution function means that there is a y % chance that the cumulative GBOR for all film projects in the portfolio will be less than $x.

Step 1010 concerns construction of the cumulative distribution function. In the example of FIG. 10, the distribution function is estimated 1010 based on historical data, for example as described above. In the flow diagram, historical data for past film projects is first analyzed 1020. Then, based on similarity between the past film projects and projects in the portfolio being securitized, a distribution function for the portfolio is estimated 1030.

Once the distribution function for the portfolio has been estimated 1010, it can be securitized 1050 in many different ways. The implementation shown in FIG. 10 divides the financial return from the portfolio into tranches (e.g., first $x1 of GBOR, next $(x2-x1) of GBOR, etc., where the values x1, x2, etc. vary from category to category) and then issues securities that are collateralized by different tranches. Securities that are collateralized by earlier tranches generally will have priority over securities collateralized by later tranches. For example, a bond-like offering based on the first tranche will be paid before an equity-like offering based on the last tranche, although the equity-like security typically would have significantly more upside potential.

In FIG. 10, the boundaries between the tranches are determined as follows. Different default levels are selected 1060 for the tranches. For example, tranche 1 may be selected to have a 1% level of default. Based on these default levels, the distribution function is used to determine 1070 the corresponding boundaries. Securities are then created 1080 based on these tranches.

Using the example of FIG. 11, it is desired for securities based on the first tranche (labeled security A in FIG. 11B) to have a risk-return characteristic similar to high-grade bonds, so a default level of 1% is selected since that is consistent with the default level for high-grade bonds. Point 1110 on the cumulative distribution function is the 1% point and the corresponding dollar value is $x1, which will vary depending on the category. Thus, the boundary between tranches 1 and 2 is set at $x1.

Similarly, it is desired for tranche 2 to have a 5% default level (point 1120), consistent with low grade bond status for security B, and so on. Note that the later tranches have default levels that are higher than bonds so they are more suitable for backing securities that behave more like equity or options. In this example, there are five tranches backing five securities, as shown in FIG. 11B. There is a one-to-one correspondence between tranches and securities, but that is not required. For example, equity and call options could be backed by the same tranche, or a single security could be backed by multiple tranches. In FIG. 11B, a call option with a strike price of $x4 could be paid out of the proceeds from tranche 5, but a put option with the same strike price (i.e., pays when GBOR is below the strike price) could be paid out of the proceeds from any of tranches 1-4 depending on the GBOR. As a final example, the entire distribution function need not be collateralized. Certain tranches could be fully or partially retained by the issuer.

The examples discussed above concern portfolios of film projects but the same principles can also be applied to portfolios of other types of entertainment projects. For example, the portfolio could be based on TV projects, sports projects (e.g., sports events, team franchises, national or international competitions), or music projects (e.g., albums, concerts), to name a few examples. The portfolio can also be based on a mix of various types of entertainment projects.

In alternate embodiments, the invention is implemented in computer hardware, firmware, software, and/or combinations thereof. In a preferred embodiment, the various steps are implemented in applications software. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

What is claimed is:

1. A method for predicting the financial performance of a portfolio of film projects, the method comprising:
identifying predictive characteristics for film projects in the portfolio; and
calculating a predicted risk and a predicted revenue for the portfolio of film projects according to a risk-return model that is based on the predictive characteristics of the film projects and accounts for historical covariance of revenue for past film projects as a function of the predictive characteristics.

2. The method of claim 1 wherein:
identifying predictive characteristics for film projects in the portfolio comprises:
performing a cluster analysis of historical revenues from past film projects as a function of attributes of the past film projects; and
based at least in part on the cluster analysis, determining a predetermined set of predictive characteristics;
calculating a predicted risk and a predicted revenue for the portfolio of film projects comprises:
classifying the film projects into segments according to the predetermined set of predictive characteristics; and
calculating a predicted risk and a predicted revenue for the portfolio of film projects according to a risk-return model that is based on historical risk and revenue for past film projects in similar segments and further based on historical covariance of revenue for past film projects in different segments.

3. The method of claim 2 wherein each predictive characteristic is clustered into not more than four possible clusters.

4. The method of claim 2 wherein the preselected set of predictive characteristic contains not more than ten predictive characteristics.

5. The method of claim 2 wherein calculating a predicted risk and a predicted revenue for the portfolio of film projects comprises:
calculating a covariance for historical revenue for past film projects as a function of the predictive characteristics; and
calculating a predicted risk and a predicted revenue for the portfolio based in part on the calculated covariance.

6. The method of claim 2 wherein the predictive characteristics include at least one secondary attribute.

7. The method of claim 2 wherein the set of predictive characteristics includes at least one predictive characteristic based on production budget.

8. The method of claim 2 wherein the set of predictive characteristics includes at least one predictive characteristic based on actors, actresses or directors.

9. The method of claim 2 wherein the set of predictive characteristics includes at least one predictive characteristic based on genre, rating or release date.

10. The method of claim 2 wherein performing a cluster analysis of historical revenues from past film projects as a function of attributes comprises:
ordering the past film projects as a function of an attribute, wherein:
if the attribute is naturally ordered, then ordering the past film projects according to the natural order, and
if the attribute is not naturally ordered, then ordering the past film projects according to revenue, and
performing the cluster analysis on the ordered past film projects.

11. The method of claim 2 wherein determining the set of predictive characteristics comprises:
selecting the set of predictive characteristics from the attributes, based on which attributes are predictive of revenue.

12. The method of claim 11 wherein determining the set of predictive characteristics further comprises:
selecting the set of predictive characteristics from the attributes, based on which attributes are not strongly correlated with each other.

13. The method of claim 2 wherein the set of predictive characteristics includes at least one predictive characteristic that was defined at least in part by regression analysis.

14. The method of claim 2 wherein the steps of performing a cluster analysis of historical revenues and determining a predetermined set of predictive characteristics are both performed iteratively.

15. The method of claim 2 wherein performing a cluster analysis of historical revenues from past film projects as a function of attributes comprises:
excluding undesirable past film projects from the cluster analysis.

16. The method of claim 1 wherein the predictive characteristics are not strongly correlated with each other.

17. The method of claim 1 wherein classifying the film projects in the portfolio into segments comprises:
dividing each predictive characteristic into clusters;
assigning each film project in the portfolio into one of the clusters for each predictive characteristic; and
classifying each film project into a segment based on the assigned clusters for the predictive characterics.

18. The method of claim 17 wherein calculating a predicted risk and a predicted revenue for the portfolio of film projects comprises:
calculating a covariance for historical revenue for past film projects as a function of the predictive characteristics; and
calculating a predicted risk and a predicted revenue for the portfolio based in part on the calculated covariance.

19. The method of claim 1 wherein calculating a predicted risk and a predicted revenue for the portfolio of film projects comprises:
classifying the film projects into segments according to a predetermined set of predictive characteristics; and
calculating a predicted risk and a predicted revenue for the portfolio of film projects according to a risk-return model that is based on historical risk and revenue for past film projects in similar segments and further based on historical covariance of revenue for past film projects in different segments.

20. The method of claim 1 further comprising:
based on the predicted risk and predicted revenue for the portfolio of film projects, creating two or more securities based on revenues from the portfolio and representing different risk-return characteristics.

21. The method of claim 20 wherein at least two of the securities are collateralized by different tranches of the revenues from the film projects in the portfolio.

22. A method for assembling a portfolio of film projects, the method comprising:
defining a target return for the portfolio of film projects;
determining whether a candidate film project contributes to achieving the target return and reducing risk of the portfolio, based on a risk-return model based on past film projects; and
acquiring rights to revenues from the candidate film project if determined that the candidate film project does contribute to achieving the target return and reducing risk of the portfolio.

23. The method of claim 22 wherein the risk-return model is based on historical risk and revenue for past film projects in similar segments and further based on historical covariance of revenue for past film projects in different segments, where segments are defined according to a preselected set of predictive characteristics.

24. The method of claim 23 wherein the preselected set of predictive characteristics is determined based on a cluster analysis of historical revenues from past film projects as a function of attributes of the past film projects.

25. The method of claim 23 wherein:
determining whether a candidate film project contributes to achieving the target return and reducing risk of the portfolio comprises determining whether the candidate film project falls in a categorically undesirable segment; and
acquiring rights to revenues from the candidate film project comprises rejecting candidate films projects that are determined to fall in categorically undesirable the segments.

26. The method of claim 22 wherein acquiring rights to revenues from the candidate film project comprises acquiring rights to revenues from candidate film projects from at least two different studios.

27. The method of claim 22 wherein:
determining whether a candidate film project contributes to achieving the target return and reducing risk of the portfolio comprises determining whether a candidate film project is categorically undesirable; and
acquiring rights to revenues from the candidate film project comprises rejecting candidate films projects that are determined to be categorically undesirable.

28. The method of claim 22 further comprising:
setting criteria for target film projects within a target portfolio, the target film projects selected based on a predicted risk and a predicted revenue for the target portfolio according to the risk-return model and according to the target return;
raising capital commitments based on the target portfolio;
acquiring rights to revenues from actual film projects in return for capital from the capital commitments, wherein the actual film projects meet criteria set for the target portfolio.

29. A system for for predicting the financial performance of a portfolio of film projects comprising:
means for identifying predictive characteristics for film projects in the portfolio; and
means for calculating a predicted risk and a predicted revenue for the portfolio of film projects according to a risk-return model that is based on the predictive characteristics of the film projects and accounts for historical covariance of revenue for past film projects as a function of the predictive characteristics.

30. A computer program product containing instructions for execution by a programmable processor to implement a method for predicting the financial performance of a portfolio of film projects, the method comprising:
identifying predictive characteristics for film projects in the portfolio; and
calculating a predicted risk and a predicted revenue for the portfolio of film projects according to a risk-return model that is based on the predictive characteristics of the film projects and accounts for historical covariance of revenue for past film projects as a function of the predictive characteristics.
